(19) United States
(12) Patent Application Publication
(10) Pub. No.: US 2013/0221950 A1
(43) Pub. Date: Aug. 29, 2013

(54) METHOD AND MEASUREMENT ARRANGEMENT FOR MEASURING MECHANICAL STRESSES IN FERROMAGNETIC WORKPIECES

(71) Applicant: Polycontact AG, (US)

(72) Inventor: Josua LANTER, Chur (CH)

(73) Assignee: Polycontact AG, Chur (CH)

(21) Appl. No.: 13/775,903

(22) Filed: Feb. 25, 2013

(30) Foreign Application Priority Data
Feb. 23, 2012 (CH) 0237/12

(51) Int. Cl. G01L 1/12

(52) U.S. Cl. CPC G01L 1/12
USPC 324/207.2; 324/207.13; 324/207.21; 324/209

(57) ABSTRACT

A method and measurement arrangement are disclosed for measuring mechanical stress in ferromagnetic workpieces, in which a ferromagnetic workpiece impresses a magnetic field and a magnetic field value is measured and analyzed with respect to the mechanical stress. The method includes at least two exciters of the magnetic field arranged along a longitudinal extension of the workpiece such that a section of the workpiece is located between the two exciters of the magnetic field. A direction-dependent magnetic field sensor is arranged at a position along the longitudinal extension of the workpiece, which can be at half the distance between the two exciters of the magnetic field. With the direction-dependent magnetic field sensor, the change in position and/or the direction of a dividing line between the north and south poles of the impressed magnetic field is determined and analyzed.

### RELATED APPLICATION(S)

This application claims priority under 35 U.S.C. §119 to Switzerland Application No. 0237/12 filed on Feb. 23, 2012, the entire content of which is hereby incorporated by reference in its entirety.

### FIELD

The disclosure relates to methods for measuring mechanical stresses produced by torsional, shearing, bending, thrusting, tensile and/or compressive forces in ferromagnetic workpieces.

### BACKGROUND INFORMATION

For investigating, characterizing and monitoring the stress states of ferromagnetic workpieces, for example, steel, magnetoelastic measuring methods are used, which can use the dependencies between mechanical and magnetic properties of ferromagnetic materials. In the case of the mechanical stressing of a ferromagnetic workpiece, as occurs, for example, when acted upon by torsional, shearing, bending, thrusting, tensile and/or compressive forces, and its forced geometric deformation, its magnetic properties and magnetic parameters can be altered.

When acted upon by external forces on steel, the characteristic values of the magnetism reversal characteristics can be altered. With increasing tensile stress, for example, the hysteresis loop becomes flatter; the slope of the hysteresis loop thus decreases, and the contributions of the magnetic characteristics drop. The magneto-elastic transformatory method of the DYNAMG Company makes use of these properties to monitor remotely existing stresses and forces in prestressed concrete parts or in steel-reinforced bridge elements. The method is based on the fact that steel that is in thermal equilibrium and that does not have any macroscopic magnetization reacts in an operating external magnetic field with a rotation of its Weiss zones in the direction of the external magnetic field vector. This domain rotation can be affected by the stress state, however, that prevails in the monitored workpiece. The method is associated with a relatively high expense, and a calibration on the respective steel grade to be examined is needed. This expense can be justifiable in the monitoring of bridge components or prestressed concrete parts, for example in power plant engineering; however, the method may not be suitable for mass-industrial applications, such as, for example, the automotive field.

An electromagnetic test method for stresses in ferromagnetic workpieces, which is known under the designation 3MA method, was developed by the German Fraunhofer Institute for Non-Destructive Test Methods. This electromagnetic method is based on the interaction of the magnetic structure that consists of domains, their Bloch wall movements, the microstructure, and the mechanical stress fields of the material. The 3MA method (Micromagnetic Multiparameter Microstructure and Stress Analysis) uses the simultaneous measurement and superposition of various magnetic effects (Barkhausen noise signal, superposition permeability, harmonic wave properties of frequency-dependent eddy current measurement values) in order to determine stretching and tensile strength properties and boundary values of workpieces. The 3MA method is calibrated on samples with known properties. Hardness, hardness depth and internal stresses can thus also be characterized with the corresponding calibration. The 3MA method thus represents a combination of several electrical and magnetic testing methods, from which their different measured values, which react differently to stress and structure influences, can be determined. The method can be relatively expensive because of the design, the analysis and the interpretation and may not be suitable for use en masse.

Another known method uses the phenomenon of magnetoconstriction, a change in length of a ferromagnetic material under the influence of a magnetic field. Conversely, a change in length produced by mechanical stresses because of external forces produces a change in the magnetic parameters of the material. The altered magnetic permeability allows a return to the inner mechanical stress state of a ferromagnetic workpiece. The imprinting of the magnetic field and the measurement of permeability can be done using two concentrically-arranged coils, which are arranged extremely close or around the ferromagnetic workpiece. The measuring principle is based on a type of eddy current measurement and analysis of the determined electrical impedance of the measuring coil. The method is used for monitoring mechanical stresses in bridge elements as well as for monitoring mechanical stresses, for example in atomic power plants. A pre-magnetization of the measured steel workpiece, which can affect the sensor operating point may be required. The method is associated with relatively high equipment cost and may not be designed for mass-industrial applications.

The above-described methods were developed primarily for the testing and monitoring of stress states and stress load limits in prestressed concrete parts or in steel-reinforced bridge elements, in which the expense and the costs of the measuring method may play a less important role.

Based on the automation of the measuring technology, however, the desire exists, even in mass-technical applications, such as, for example, in the automotive field, or, for example, in the generation of energy by means of windmills, to monitor the mechanical stress loads produced by torsional, shearing, bending, thrusting, tensile and/or compressive forces in workpieces, in order to match and to optimize the operating parameters based on the measured stress values.

One method for determining stress states of a workpiece uses wire-strain gauges, which are bonded to the test piece. Using the wire-strain gauge, for example, a stress-induced deformation of the workpiece can be converted into an electrical voltage. The wire-strain gauge can be bonded to the workpiece with as little slip as possible so that it can follow any expansion of the surface. Bonded compounds can fail because of mechanical influences, under the action of moisture, contamination and temperature changes. Wire-strain gauges can also have relatively slight sensitivity, which is manifested as a small signal-noise ratio and can limit the use of wire-strain gauges to relatively large expansions.

For monitoring stresses due to torque on rotating shafts, it is known to impress opposite orientations of the magnetic field on areas adjacent to the shaft. The changes in the directions of the magnetic fields in the individual zones can then be scanned with a direction-dependent magnetic field sensor and analyzed with respect to mechanical stresses. The changes in torque that occur with this method can be easy to determine. However, the effort involved in impressing opposite directions of the magnetic field onto areas on the shaft can be very costly and labor-intensive.

### SUMMARY

A method is disclosed for measuring mechanical stresses in a ferromagnetic workpiece, comprising: arranging at least two exciters of a magnetic field along a surface of a ferromagnetic workpiece, wherein a section of the workpiece is located between the at least two exciters of the magnetic field; arranging a direction-dependent magnetic field sensor at a position along the surface of the workpiece between the at least two exciters; determining a change in position and/or a direction of a dividing line between north and south poles of the magnetic field with the direction-dependent magnetic field sensor; and analyzing the change in the position and/or direction of the north and south poles of the magnetic field to measure mechanical stress in the workpiece.

A measurement arrangement is disclosed for measuring mechanical stress in a ferromagnetic workpiece, comprising: at least two exciters of a magnetic field for arrangement along a surface of a ferromagnetic workpiece, such that a section of the workpiece will be located between the at least two exciters of the magnetic field; and a direction-dependent magnetic field sensor positioned relative to the at least two exciters for arrangement at a position along a surface of the workpiece once positioned between the at least two exciters.

### BRIEF DESCRIPTION OF THE DRAWINGS

In the following, the disclosure will be described in greater detail by exemplary embodiments with reference to the attached drawings, in which:

FIG. 1 shows an exemplary embodiment of a diagrammatic representation of a workpiece with two permanent magnets fastened thereto and a direction-dependent magnetic field sensor;

FIG. 2 shows the workpiece with the exemplary measurement arrangement according to FIG. 1 under compressive stress;

FIG. 3 shows the workpiece with an exemplary measurement arrangement according to FIG. 1 under torsional stress;

FIG. 4 shows a diagrammatic representation of a modified exemplary arrangement of two permanent magnets and a direction-dependent magnetic field sensor;

FIG. 5 shows an exemplary embodiment of the arrangement of permanent magnets and direction-dependent magnetic field sensors on a workpiece;

FIG. 6 shows the workpiece with the exemplary measurement arrangement according to FIG. 5 under compressive stress;

FIGS. 7a-7c show exemplary embodiments of measurement arrangements for implementing the method according to the disclosure; and

FIGS. 8a-8b show exemplary embodiments of measurement arrangements for implementing the method according to the disclosure.

### DETAILED DESCRIPTION

A method and a measurement arrangement is disclosed for measuring mechanical stresses produced by torsional, shearing, bending, thrusting, tensile and/or compressive forces in ferromagnetic workpieces are to be provided, which can allow small deformations to be reliably detected. For example, the method and the measurement arrangement can be suitable for mass-industrial applications, such as, for example, the automotive field. Moreover, the method can be simply and economically performable, and the measurement arrangement can have a simple and economical design.

In accordance with an exemplary embodiment, a method for measuring mechanical stresses in ferromagnetic workpieces is disclosed, in which a ferromagnetic workpiece impresses a magnetic field and a magnetic field value can be measured and analyzed with respect to the mechanical stress, wherein at least two exciters of the magnetic field can be arranged along the surface of the workpiece in such a way that a section of the workpiece is located between the two exciters of the magnetic field, a direction-dependent magnetic field sensor is arranged at a position along the surface of the workpiece, for example, approximately at half the distance between the two exciters of the magnetic field, and with the direction-dependent magnetic field sensor, the change in position and/or the direction of a dividing line between the north and south poles of the magnetic field is determined and analyzed (e.g., via a processor).

A method for measuring mechanical stresses in ferromagnetic workpieces is disclosed, in which method a ferromagnetic workpiece impresses a magnetic field and a magnetic field value is measured and analyzed with respect to the mechanical stress. In accordance with an exemplary embodiment, at least two exciters of the magnetic field can be arranged along the surface of the workpiece in such a way that a section of the workpiece can be located between the two exciters of the magnetic field. A direction-dependent magnetic field sensor is arranged at a position along the surface of the workpiece, which can be approximately at half the distance (or mid-point) between the two exciters of the magnetic field. With the direction-dependent magnetic field sensor, the change in position and/or the direction of a dividing line between the north and south poles of the magnetic field can be determined and analyzed.

For an exemplary implementation, the method according to the disclosure can include two exciters for a magnetic field and a direction-dependent magnetic field sensor including a connected analysis unit, which can be integrated into the magnetic field sensor. In accordance with an exemplary embodiment, the method uses the dependencies between mechanical and magnetic properties of ferromagnetic materials. In the case of the mechanical stressing of the ferromagnetic workpiece, as occurs, for example, when acted upon by torsional, shearing, bending, thrusting, tensile and/or compressive forces, and its forced geometric deformation, its magnetic properties and magnetic parameters can be altered. The direction-dependent magnetic field sensor can detect the shifting of the boundary between the north and south poles of the impressed magnetic field or the change in direction of the magnetic field vector. The measured values can be analyzed in order to determine therefrom the mechanical stress in the workpiece. In accordance with an exemplary embodiment, the type of material, and the type of alloy, can be taken into consideration by comparison with empirically determined values, and the determined stress value can be correspondingly corrected.

The arrangement of the exciters for the magnetic field can be suitably carried out in such a way that they are spaced apart in the longitudinal direction of the ferromagnetic workpiece. In addition, the exciters for the magnetic field can also be spaced apart angularly.

In accordance with an exemplary embodiment, the method can be implemented with only two exciters for the magnetic field and with a direction-dependent magnetic field sensor that is arranged in between the two exciters. In accordance with an exemplary embodiment, the assessment on the stresses prevailing in the workpiece can include n exciters for the magnetic field to be arranged and/or spaced apart along the longitudinal extension of the workpiece in such a way that sections with reversed orientation of the impressed magnetic field can be created on the workpiece. For example, a number of n−1 direction-dependent magnetic field sensors can be arranged in each case approximately at half the distance between two successive exciters of the magnetic field. The signals measured by the n−1 direction-dependent magnetic field sensors can be linked to one another for determining the stress state of the workpiece.

An exemplary embodiment of the disclosure can include permanent magnets to be used as exciters for the magnetic field. In accordance with an exemplary embodiment, permanent magnets can be economical and, despite a small design, can generate a relatively high magnetic field strength when using corresponding materials. For example, as permanent magnets, magnets that consist of SmₓCo_{y}, ferrite, NdFeB or plastic-bonded magnets can be used.

In an exemplary embodiment of the method according to the disclosure, the exciters for the magnetic field, for example the permanent magnets, can be rigidly connected to the workpiece. For example, the exemplary embodiment can be used for static or stationary workpieces, for example, in the case of steering links of motor vehicles, in prestressing steels in the construction industry, or in steel-reinforced concrete parts. The connection of the permanent magnets with the workpiece can be done, for example, integrally, for example, by gluing, soldering, or bonding. In the case of permanent magnets connected rigidly to the surface of the workpiece, the method according to the disclosure can be implemented on non-ferromagnetic workpieces.

An exemplary embodiment of the disclosure can include for the n exciters for the magnetic field and the n−1 sensors to be arranged in a common housing, which can be arranged in the immediate vicinity of the ferromagnetic workpiece for contact-free measurement of the mechanical stresses. In accordance with an exemplary embodiment, the method according to the disclosure can be implemented by means of a measuring device whose geometric design can be matched to the respective special application. For example, components of the housing can be exchanged, or the arrangement of the exciters for the magnetic field and the direction-dependent magnetic field sensors can be altered within the housing in order to match the measuring device to the special specifications.

In accordance with an exemplary embodiment, instead of the permanent magnets, a source for an electromagnetic DC (direct current) field can also be used as an exciter for the magnetic field. For example, DC carrying conductors or conductor loops, which can be arranged next to the workpiece.

An exemplary embodiment of the disclosure can include an electromagnetic AC (alternating current) field that can be superimposed on the electromagnetic DC fields. For example, to determine the mechanical stresses in the ferromagnetic material, in addition to the change in direction of the dividing line between the north and south poles of the magnetic field, its permeability and/or its differential permeability and/or its superposition permeability and/or the change in amplitude in the magnetic field and/or the oscillation behavior of the change in the magnetic field can be measured. The superposition of the magnetic DC field and the magnetic AC field can broaden the spectrum of the detectable measurement values from which material parameters and the respective mechanical stress state can be derived.

In accordance with an exemplary embodiment, the method according to the disclosure with the measuring structure according to the disclosure can be implemented with widely varying types of magnetic field sensors in order to precisely determine different material parameters from the measurement values. For example, sensors from the group that consists of flux-gate magnetometers, coils with ferrite cores, Hall sensors and magnetoresistive sensors can be used as direction-dependent magnetic field sensors for determining mechanical stresses produced by torsional, shearing, bending, thrusting, tensile and/or compressive forces in ferromagnetic workpieces.

In accordance with an exemplary embodiment, because of the structure according to the disclosure, for example, the method can be suitable for applications in the automotive field. For example, the method for continuous steering-wheel monitoring can be used to supply the desired force feedback to the connecting rod by means of a corresponding input into the servo support of the steering. The method can also be used for continuous fine adjustment of the travelling-gear setting of a motor vehicle, by, for example, the stresses in the steering links or stabilizers of a motor vehicle being monitored and being matched to the shock-absorber properties depending on the measured stress values. For example, the chassis frame properties can be matched to the respective existing specifications. In accordance with an exemplary embodiment, the method according to the disclosure in the automotive field consists in the continuous monitoring of the drive chain in order to optimize the torque that occurs in the transmission.

The method according to the disclosure with the measurement arrangement according to the disclosure can also be used for the monitoring of mechanical stresses in a rotating shaft. For example, the use of magnetically-coded shafts replaces the arrangement according to the disclosure of the exciters for the magnetic field. In accordance with an exemplary embodiment, the method can be used for the monitoring of the torque of drilling equipment or of screwing devices. For example, the torque can be optimized, and in the case of screwing devices, the method according to the disclosure can be used to tighten a screw with minimal torque variations.

In accordance with an exemplary embodiment, the method according to the disclosure can be used, for example, for monitoring mechanical stresses in components of windmills. Other applications relate to the monitoring of stress states in pre-stressed steel structures, for example bridges or buildings, in reinforced concrete components.

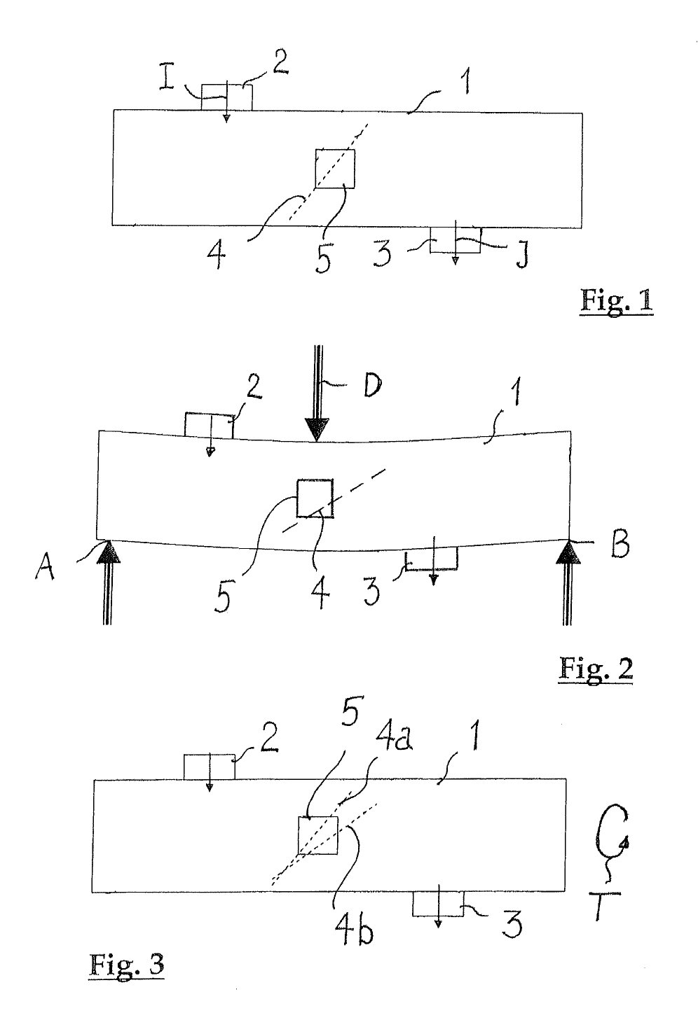

The diagrammatic representation in FIG. 1 shows a section of a workpiece 1 that consists of a ferromagnetic material, for example, a shaft made of steel. Two permanent magnets 2, 3, whose direction of magnetization is indicated by the arrows I and J, can be arranged spaced apart on the top and on the bottom of the workpiece 1 along its lengthwise extension. The permanent magnets 2, 3 can be, for example, magnets that consist of SMₓCO_{y}, ferrite, NdFeB or plastic-bonded magnets. In accordance with an exemplary embodiment, instead of permanent magnets, a source for an electromagnetic DC field can also be provided. For example, instead of the permanent magnets, DC-carrying conductors can also be arranged. The direction of magnetization I, J of the two permanent magnets 2, 3 runs, according to an exemplary embodiment as shown, perpendicular to the longitudinal extension of the ferromagnetic workpiece 1. The permanent magnets, however, can also be arranged in such a way that their direction of magnetization runs parallel to the longitudinal extension of the ferromagnetic workpiece. For example, at approximately half the distance between the two permanent magnets 2, 3, a direction-dependent magnetic field sensor 5 can be arranged. The magnetic field sensor 5 can, for example, be a Hall sensor. Instead of a Hall sensor, however, a flux-gate magnetometer, a coil with a ferrite core or a magnetoresistive sensor can also be used. The magnetic field sensor 5 can be used for detection of the position and/or the orientation of a boundary between the south pole and the north pole of the magnetic field that is impressed on the ferromagnetic workpiece by the two permanent magnets 2, 3, the magnetic field being provided in FIG. 1 with the reference number 4.

FIG. 2 shows the ferromagnetic workpiece 1 with the measurement arrangement (permanent magnets 2, 3 and magnetic field sensor 5) according to FIG. 1 under compressive stress, which is indicated in FIG. 2 by the arrow D. The two expansion bearings on the bottom of the workpiece 1 are provided with the reference numbers A and/or B. The same components in each case bear the same reference numbers as in FIG. 1. Under the mechanical compressive stress and the thus forced geometric deformation, the magnetic properties and magnetic parameters of the ferromagnetic workpiece 1 can be altered. For example, this can be expressed in the boundary 4 between the north and south poles of the magnetic field impressed by the permanent magnets 2, 3 spatially shifts and/or alters its direction. This spatial shifting or rotation can be detected with the direction-dependent magnetic field sensor 5. The measured values can be analyzed with algorithms known in the art—for example, impedance measurement, LC oscillator circuit, RL oscillator circuit, transformers, coupling measurement, etc., for example, in order to precisely determine therefrom the mechanical stresses in the workpiece 1. For example, the type of material, the type of alloy, etc., can be taken into consideration by comparison with empirically determined values, and the determined stress value can be correspondingly corrected.

FIG. 3 shows the ferromagnetic workpiece 1 with the measurement arrangement according to FIG. 1 under a torsional stress, which is indicated in FIG. 3 by the curved arrow T. The same components in turn bear the same reference numbers as in FIG. 1. The spatial shifting and rotation of the direction of the boundaries between the north and south poles of the magnetic field impressed on the workpiece 1 by the two permanent magnets 2, 3 are shown with the two broken lines 4a, and 4b. In accordance with an exemplary embodiment, the line 4a reproduces the state without mechanical stress, while the line 4b indicates the source of the boundaries with torsional stress T. The spatial shift or rotation of the boundaries between the north and south poles of the magnetic field can be detected in turn with the direction-dependent magnetic field sensor 5 in order to determine the mechanical stresses prevailing in the workpiece 1 from the measured values.

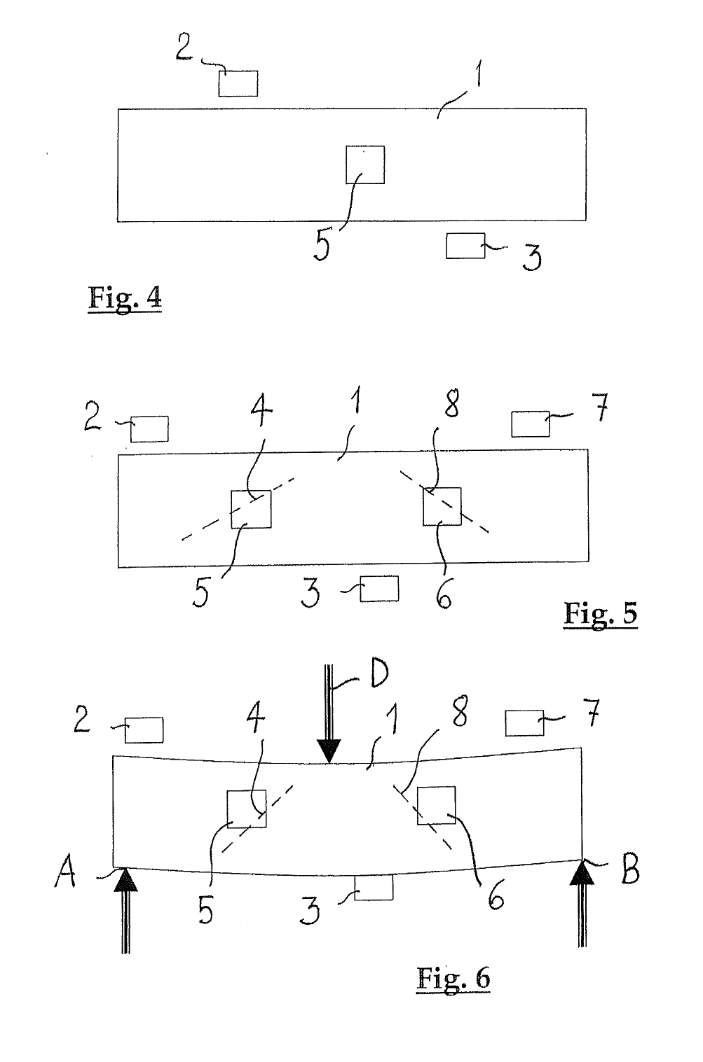

The measurement arrangement (permanent magnets 2, 3 and direction-dependent magnetic field sensor 5) can, as indicated in FIGS. 1-3, be connected rigidly, for example, glued, soldered or bonded, with the ferromagnetic workpiece 1. In an alternative exemplary embodiment of the measurement arrangement, which is indicated in FIG. 4, the permanent magnets 2, 3 and the direction-dependent magnetic field sensors 5 can be slightly spaced apart from the ferromagnetic workpiece 1. In an exemplary embodiment, which is not shown separately, the measurement arrangement can be arranged within a housing that is arranged for the measurement method in the immediate vicinity of the ferromagnetic workpiece. In accordance with an exemplary embodiment, the components of the housing can be interchangeable or the arrangement of the permanent magnets and the direction-dependent magnetic field sensors within the housing can be varied in order to match the measurement arrangement to the special specifications. With a measurement arrangement according to FIG. 4 or with a measurement arrangement that is arranged in a housing, a contact-free measurement method can be made.

FIG. 5 shows a ferromagnetic workpiece, which in turn bears the reference number 1, with a measurement arrangement that comprises three permanent magnets 2, 3, 7 and two direction-dependent magnetic field sensors 5, 6. Two permanent magnets 2, 7 are arranged on the top of the workpiece 1; a permanent magnet 3 can be located on the bottom of the workpiece 1. The permanent magnets that are arranged alternately on the top and on the bottom of the workpiece 1 can be approximately the same distance from one another. The permanent magnets 2, 3 or 3, 7 that in each case work together in pairs define sections on the workpiece 1, in which a boundary 4 or 8 between the north pole and the south pole of the impressed magnetic field has an opposite direction or slope. The respective boundary 4 or 8 between the north pole and the south pole of the magnetic field that is impressed on the workpiece 1 runs approximately halfway between a pair of permanent magnets 2, 3 or 3, 7. In accordance with an exemplary embodiment, a direction-dependent magnetic field sensor 5 or 6 can be arranged approximately in this area. As indicated in FIG. 5, the components of the measurement arrangement (permanent magnets 2, 3, 7 and magnetic field sensors 5, 6) can be slightly spaced apart from the workpiece 1, in order to allow a contact-free measurement.

FIG. 6 shows the ferromagnetic workpiece 1 with the measurement arrangement according to FIG. 5 under compressive stress, which is indicated in FIG. 6 by the arrow D. The arrows A and B in each case refer to expansion bearings on the bottom of the workpiece 1. The magnetic properties and the magnetic parameters of the ferromagnetic workpiece 1 can be altered under the mechanical compressive stress D and the thus forced geometric deformation. In accordance with an exemplary embodiment, because of the bending of the workpiece 1, the distance of the permanent magnets 2, 3, 7 from the workpiece can also be altered. A spatial shifting and/or rotation of the boundary 4 or 8 between the north and south poles of the magnetic field impressed by a related pair of permanent magnets 2, 3 or 3, 7 in the respective section of the workpiece 1 results therefrom. These spatial shiftings or rotations of the boundaries between the north and south poles of the magnetic field can be detected with the direction-dependent magnetic field sensors 5, 6. The measured values can then be analyzed with the algorithms that are known in the art, in order to precisely determine therefrom the mechanical stresses in the workpiece 1 or in the individual sections. For example, the type of material, the type of alloy, can be taken into consideration by comparison with empirically determined values, and the stress value that is determined can be correspondingly corrected.

The measurement arrangement is not limited to the numbers of permanent magnets and direction-dependent magnetic field sensors depicted, for example, in FIGS. 1-6. For example, along a ferromagnetic workpiece, n permanent magnets can be arranged spaced apart, whereby in each case, a pair of permanent magnets impresses a magnetic field of specific orientation onto a section of the workpiece. A corresponding number of n−1 direction-dependent magnetic field sensors can be assigned to the number of n−1 sections of the workpiece resulting therefrom, with which sensors the alteration of the orientation of the magnetic field into the corresponding sections can be detected, in order to determine the mechanical stresses therefrom for each section of the workpiece.

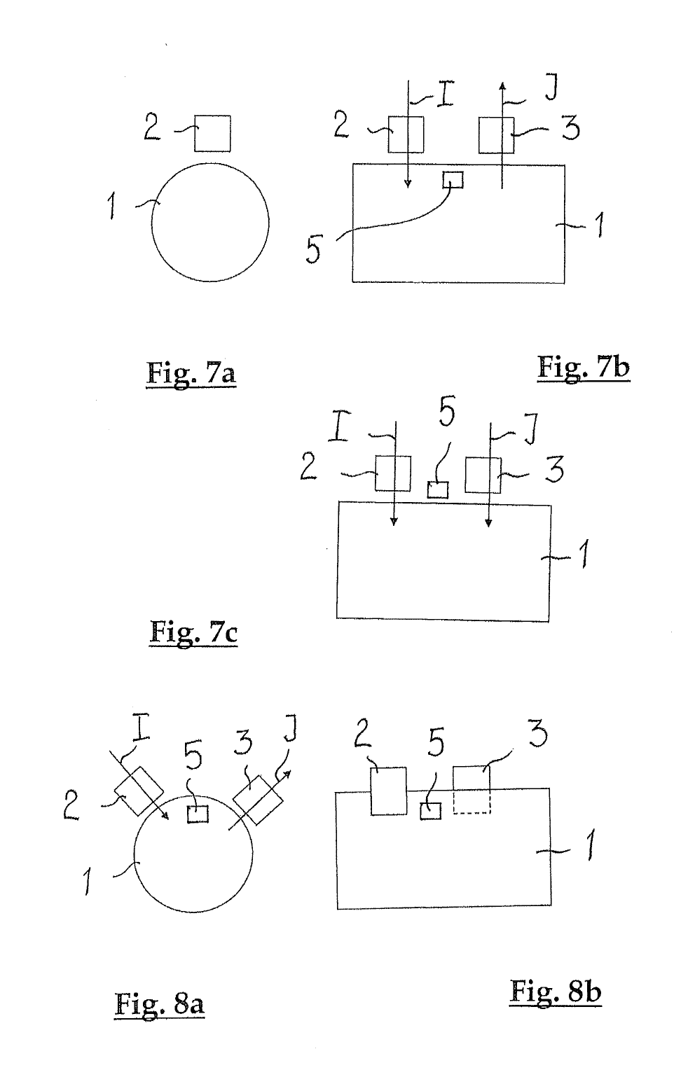

FIG. 7a and FIG. 7b show two views of an exemplary embodiment of an arrangement of permanent magnets 2, 3 and a direction-dependent magnetic field sensor 5 along a ferromagnetic workpiece, which in turn bears the reference number 1. As FIG. 7b shows, both permanent magnets 2, 3 can be arranged spaced apart along the lengthwise extension of the workpiece 1 on its top. The direction-dependent magnetic field sensor can be suitably placed approximately halfway between the two magnetic field sensors 2, 3. The two permanent magnets 2, 3 are arranged, for example, in such a way that their magnetization directions I, J run opposite one another.

In an exemplary measurement arrangement, which is indicated in FIG. 7c, the two permanent magnets 2, 3 can be arranged in such a way that their magnetization directions I, J point in the same direction.

FIGS. 8a and 8b show two views of an exemplary embodiment of a measurement arrangement for implementing the method according to the disclosure. In addition, spaced apart along the longitudinal extension of the ferromagnetic workpiece provided in turn with the reference number 1, the two permanent magnets 2 and 3 also can be spaced apart angularly. The magnetization directions of the two permanent magnets 2, 3 are indicated with the reference numbers I, J. The direction-dependent magnetic field sensor 5 can be arranged, for example, approximately halfway between the two permanent magnets 2, 3.

In the measurement arrangements depicted in FIGS. 7a-7c and 8a-8b, the permanent magnets can be connected rigidly to the surface of the workpiece or they can, as depicted, can be placed next to its surface. As an alternative, the permanent magnets and the direction-dependent magnetic field sensors can also be arranged in a separate housing, which is arranged to perform the measurement in the immediate vicinity of the workpiece.

The method according to the disclosure can be implemented with a relatively simply-designed measurement arrangement and can be used in the most varied applications. Examples include the automotive field, the monitoring of stresses in prestressed elements of bridges and buildings, the optimization and control of torque in rotating components in engines, drilling equipment and screwing devices.

Thus, it will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

What is claimed is:

1. A method for measuring mechanical stresses in a ferromagnetic workpiece, comprising:
arranging at least two exciters of a magnetic field along a surface of a ferromagnetic workpiece, wherein a section of the workpiece is located between the at least two exciters of the magnetic field;
arranging a direction-dependent magnetic field sensor at a position along the surface of the workpiece between the at least two exciters;
determining a change in position and/or a direction of a dividing line between north and south poles of the magnetic field with the direction-dependent magnetic field sensor; and
analyzing the change in the position and/or direction of the north and south poles of the magnetic field to measure mechanical stress in the workpiece.

2. The method according to claim 1, comprising:
positioning the direction-dependent magnetic field sensor at approximately half-way between the at least two exciters of the magnetic field.

3. The method according to claim 1, comprising:
arranging the at least two exciters of the magnetic field along the surface of the ferromagnetic workpiece, wherein the at least two exciters of the magnetic field are spaced apart in a direction of a longitudinal extension of the ferromagnetic workpiece.

4. The method according to claim 1, comprising:
arranging n exciters of a magnetic field, wherein the n exciters are spaced apart along a longitudinal extension of the workpiece, and wherein sections with reversed orientation of an impressed magnetic field are created on the workpiece, and a number of n−1 direction-dependent magnetic field sensors are arranged approximately at half a distance between two successive exciters of the magnetic field, and whereby signals measured by the direction-dependent magnetic field sensors are linked to one another for determining mechanical stress of the workpiece.

5. The method according to claim 1, comprising:
using permanent magnets for the at least two exciters of the magnetic field.

6. The method according to claim 5, wherein the permanent magnets comprises:
SmₓCo_{y}, ferrite, NdFeB, or plastic-bonded magnets

7. The method according to claim 1, comprising:
permanently connecting the at least two exciters to the ferromagnetic workpiece.

8. The method according to claim 7, wherein the at least two exciters of the magnetic field are configured to be integrally connected to the workpiece by gluing, soldering, or bonding the at least two exciters to the workpiece.

9. The method according to claim 4, comprising;
arranging the n exciters for the magnetic field and the n−1 direction-dependent magnetic field sensors in a common housing, which is arranged in an immediate vicinity of the ferromagnetic workpiece for a contact-free measurement of mechanical stress.

10. The method according to claim 1, comprising:
using an electromagnetic DC field for the at least two exciters of the magnetic field.

11. The method according to claim 10, comprising:
superimposing an electromagnetic AC field on the electromagnetic DC field; and
determining the mechanical stresses in the ferromagnetic workpiece by measuring permeability, differential permeability, superposition permeability, change in amplitude of the magnetic field, and/or oscillation behavior of the change in the electromagnetic field.

12. The method according to claim 1, comprising:
using sensors from a group consisting of one or more of flux-gate magnetometers, coils with ferrite cores, Hall sensors and magnetoresistive sensors for the direction-dependent magnetic field.

13. The method according to claim 1, comprising:
measuring the mechanical stress in the ferromagnetic workpiece in an automotive field.

14. The method according to claim 1, comprising:
measuring mechanical stress in ferromagnetic workpieces for continuous steering-wheel monitoring, for continuous fine adjustment of the travelling-gear setting of a motor vehicle, and/or for optimization of torque in a transmission of a motor vehicle.

15. The method according to claim 1, comprising:
monitoring mechanical stress in a rotating shaft.

16. The method according to claim 1, comprising:
monitoring mechanical stress in a component of a windmill.

17. A measurement arrangement for measuring mechanical stress in a ferromagnetic workpiece, comprising:
at least two exciters of a magnetic field for arrangement along a surface of a ferromagnetic workpiece, such that a section of the workpiece will be located between the at least two exciters of the magnetic field; and
a direction-dependent magnetic field sensor positioned relative to the at least two exciters for arrangement at a position along a surface of the workpiece once positioned between the at least two exciters.

18. The measurement arrangement according to claim 17, wherein the direction-dependent magnetic field sensor is arranged approximately halfway between the at least two exciters of the magnetic field.

19. The measurement arrangement according to claim 17, in combination with a ferromagnetic workpiece, wherein the at least two exciters for the magnetic field are permanent magnets.

20. The measurement arrangement according to claim 17, wherein the at least one direction-dependent magnetic field sensor is a sensor selected from a group that consists of one or more of flux-gate magnetometers, coils with ferrite cores, Hall sensors, and magnetoresistive sensors.
